(19) United States
(12) Patent Application Publication
(10) Pub. No.: US 2014/0244240 A1
(43) Pub. Date: Aug. 28, 2014

(54) Determining Explanatoriness of a Segment

(71) Applicant: HEWLETT-PACKARD DEVElOPMENT COMPANY, L.P., (US)

(72) Inventors: HyunDuk Kim, Champaign, IL (US); Maria G. Castellanos, Palo Alto, CA (US); Meichun Hsu, Palo Alto, CA (US); Cheng Xiang Zhai, Champaign, IL (US)

(73) Assignee: HEWLETT-PACKARD DEVElOPMENT COMPANY, L.P., Houston, TX (US)

(21) Appl. No.: 13/778,455

(22) Filed: Feb. 27, 2013

(51) Int. Cl. G06F 17/27

(52) U.S. Cl. CPC G06F 17/27
USPC 704/9

(57) ABSTRACT

A technique may include generating a segment from a sentence using a probabilistic model or structure. The probabilistic model/structure may be based on a Hidden Markov Model (HMM). The technique may further include determining an explanatoriness score of the segment using the probabilistic model/structure.

### RELATED APPLICATIONS

This application is related to U.S. patent application Ser. No. 13/485,730, entitled “Generation of Explanatory Summaries” by Kim et al., filed on May 31, 2012, and to U.S. patent application Ser. No. 13/766,019, entitled “Determining Explanatoriness of Segments” by Kim et al., filed on Feb. 13, 2013, each of which is hereby incorporated by reference in its entirety.

### BACKGROUND

A plethora of opinion information is often available for products, services, events, and the like. For example, with the advent of the Internet, web pages, ecommerce platforms, social media platforms, etc. have provided people with the ability to easily share their opinions. For instance, on many ecommerce sites, customers are often able to submit reviews and ratings regarding products they have purchased or services they have received. Additionally, people often share their opinion regarding a product or service via social media posts.

This opinion information may be collected for analysis. For example, a company selling a product may desire to know what customers are saying about the product. But reading through each opinion one by one can be a time-consuming, inefficient, and arduous task. While there are computer-aided techniques of determining the overall sentiment of reviews and ratings, it can be a challenge to determine the reasons behind the sentiments. However, knowledge of the multiple reasons underlying an opinion or sentiment may be very helpful to a company.

### BRIEF DESCRIPTION OF DRAWINGS

The following detailed description refers to the drawings, wherein:

FIG. 1 illustrates a method of generating and scoring a segment, according to an example.

FIG. 2 illustrates an example of a Hidden Markov Model for generating segments and evaluating explanatoriness, according to an example.

FIG. 3 illustrates a method of determining an explanatoriness score, according to an example.

FIG. 4 illustrates a process overview for generating and scoring segments, according to an example.

FIG. 5 illustrates a method of generating an explanatory summary, according to an example.

FIG. 6 illustrates a system for generating and scoring segments, according to an example.

FIG. 7 illustrates a computer-readable medium for generating and scoring segments, according to an example.

### DETAILED DESCRIPTION

According to an example, a technique of generating an explanatory summary of a data set is provided. The terms “explanatory” and “explanatoriness” are used herein to denote that a text portion has been determined to provide an underlying reason or basis for an opinion. The data set can include multiple sentences relating to any of various things, such as opinions of a particular character. In one example, the opinions have a particular polarity and relate to a particular aspect of a product. For instance, the data set may include positive opinions regarding the touchscreen of Tablet Computer X.

The technique can include determining features of a sentence from the data set. “Features” is used in this context in the machine learning/classification sense. Accordingly, for example, features of a sentence may be individual words or groups of words within the sentence. The technique can further include generating a candidate segment from the features of the sentence using a probabilistic model. The probabilistic model can employ a Hidden Markov Model (HMM) algorithm. The probabilistic model may include a non-explanatory state and an explanatory state, each of which is associated with a language model. The candidate segment may be a sequence generated by the explanatory state of the probabilistic model. Additional candidate segments may be generated from the sentence by removing the generated segment from the sentence and applying the probabilistic model to the modified sentence in a recursive fashion. Also, additional candidate segments may be generated by applying the probabilistic model to other sentences from the data set.

The inventors have discovered that using a HMM-based probabilistic model in this fashion is an intelligent method of identifying candidates for an explanatory summary, since the generated segments have been determined by the model to be likely explanatory. Additionally, processing time may be saved since every possible subsequence of a sentence need not be generated and evaluated for explanatoriness. This benefit becomes more apparent as the size of the data set increases.

The technique can further include determining an explanatoriness score of the candidate segments using the probabilistic model. Evaluating the explanatoriness of a segment using the probabilistic model can include evaluating the popularity of the segment and the discriminativeness of the segment. The popularity of the segment may be reflective of how frequently terms in the segment appear in the data set. The discriminativeness of the segment may be reflective of how discriminative terms in the segment are relative to a second data set (e.g., a measure of how infrequently the terms appear in the second data set). The second data set may be a superset of the first data set and thus may include additional information. For instance, the superset of the example data set above could be a data set containing both positive and negative opinions of all aspects of Tablet Computer X (rather than just positive opinions regarding the touchscreen of Tablet Computer X).

Each segment may be ranked based on the explanatoriness score. The segment having the highest rank may be selected for inclusion in an explanatory summary. Before segments are selected for inclusion, a redundancy check may be performed to ensure that the segment is not likely redundant to other segments already selected for inclusion in the summary. Additionally, after a highest ranked segment is selected, the selected segment may be removed from the first data set and the entire technique may be repeated. After a threshold has been met, the summary may be generated and output. As a result, an explanatory summary providing reasons for opinions of a particular character may be provided. Moreover, because the summary includes explanatory segments rather than entire sentences having explanatory portions, it may be more likely that all of the information in the summary is relevant. Additional examples, advantages, features, modifications and the like are described below with reference to the drawings.

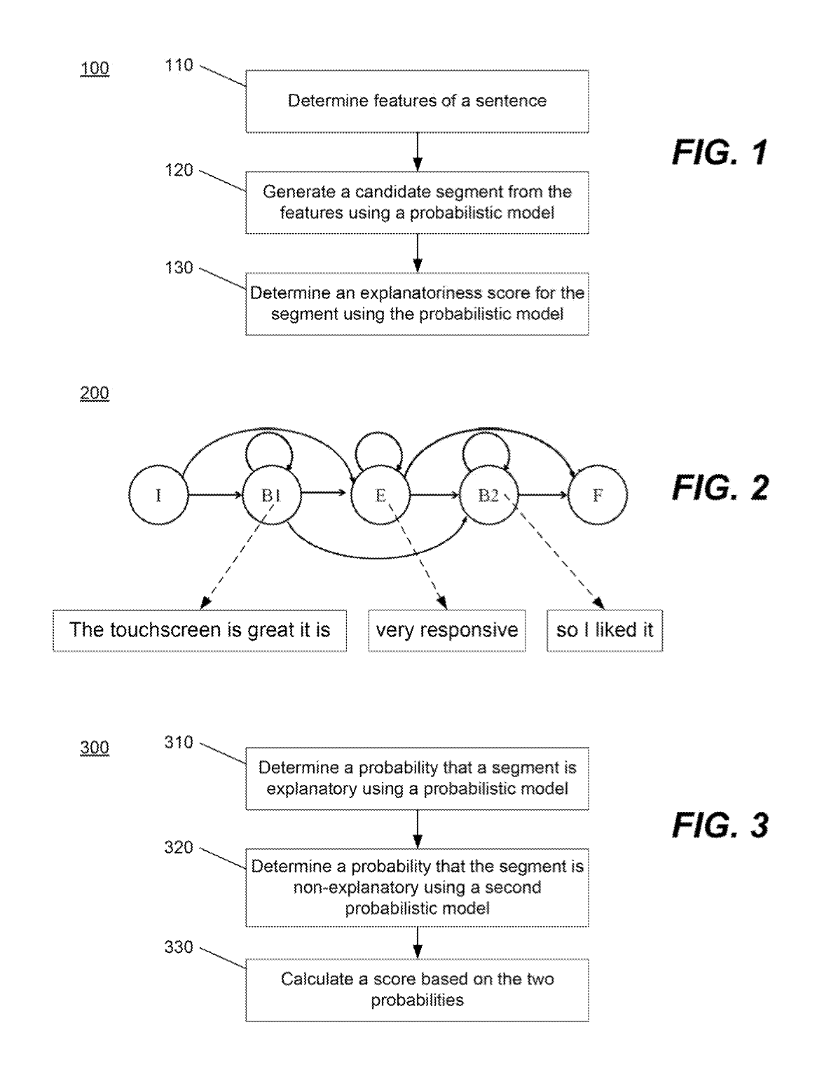

FIG. 1 illustrates a method of generating and scoring a segment, according to an example. Method 100 may be performed by a computing device, system, or computer, such as computing system 600 or computer 700. Computer-readable instructions for implementing method 100 may be stored on a computer readable storage medium. These instructions as stored on the medium may be called modules and may be executed by a computer.

Method 100 may begin at 110, where features may be determined for a sentence. As noted above, the term “features” is used in this context in the machine learning/classification sense. Accordingly, for example, features of a sentence may be individual words or groups of words within the sentence. These features may be used for analyzing the sentence using a probabilistic model, as described in more detail below.

The sentence can be one of many sentences in a data set. The term “sentence” is used herein to denote a portion of text in the data set that, for purposes of the data set, is considered to be a single unit. For example, the data set may include text portions separated by some separator, such as a carriage return, a period, a comma, or the like. Such text portions would be considered the sentences of the data set. In one instance, the text portions may be grammatical sentences. In another instance, the text portions may be blocks of text relating to an expression of an idea or opinion, such as an entire product review submitted by a user or a portion of the review. The text portion may be defined by other boundaries as well, and may be dependent solely on the structure of the data set.

The data set may include information related to any of various things. For example, the data set can relate to product information, opinions, technical papers, web pages, or the like. With reference to opinions, the data set might include opinions regarding a product, service, event, person, or the like.

Throughout this description, examples will be described in the context of opinions regarding a product. In addition, the data set may be limited to opinions having a particular character. For example, the opinions may relate to an aspect of a product and may have a particular polarity (e.g., positive, negative, or neutral). An “aspect” may include product features, functionality, components, or the like. For instance, the data set may include positive opinions regarding the touchscreen of Tablet Computer X. The opinions may be compiled from a variety of sources. For example, the opinions may be the result of customer reviews on an ecommerce website, articles on the Internet, or comments on a website.

The opinions may go through various pre-processing steps. For example, one of ordinary skill in the art may use various opinion mining techniques, systems, software programs, and the like, to process a large batch of opinion data. Such techniques may be used to cluster opinions into a variety of categories. For example, the opinions can be clustered by product if such clustering is not already inherent in the batch. For instance, opinions relating to a printer may be clustered into one duster while opinions relating to a tablet computer may be clustered into another cluster. The opinions may be further clustered as relating to particular aspects of the product. For instance, in the tablet computer duster, the opinions may be clustered as relating to the touchscreen, the user interface, the available applications, the look and feel of the tablet, the power adapter, etc. The opinions may be further clustered by polarity of the opinion. For instance, in the touchscreen cluster, the opinions may be clustered as “positive”, “negative”, or “neutral”. In some examples, the disclosed techniques may be part of an opinion analysis system or pipeline of processing performed on an opinion data set, such that the output of the opinion mining techniques are the input of the explanatory summary generation techniques.

Throughout the description, the term “opinion data set” will be used to refer to a first data set for which we are trying to generate an explanatory summary, and the term “background data set” will be used to refer to a second data set containing additional information not in the opinion data set. In the Tablet Computer X example described herein, the background data set is a superset of the opinion data set. In some examples and applications, though, the background data set may not be a superset of the opinion data set. However, the background data set should be different from the opinion data set so that the discriminativeness of candidate segments can be measured.

Method 100 may continue to 120, where candidate segments may be generated. The inventors have discovered that treating a data sets sentences as units (i.e., respecting the sentence boundaries established by or inherent in the data set) for purposes of determining explanatoriness has a number of potential disadvantages that could lead to a less useful explanatory summary. For example, a single sentence may have both relevant and irrelevant information. If the sentence receives a high explanatoriness score due to the relevant information, then the sentence may be included in the summary even though there is irrelevant information, which can decrease the quality and utility of the summary. On the other hand, if the sentence receives a lower explanatoriness score due to the irrelevant information, then the sentence may be excluded from the summary even though it has relevant information that would increase the quality and utility of the summary.

Accordingly, at 120 a candidate segment may be generated from the features of the sentence. The candidate segment may be a sequence of features of the sentence and may thus be smaller than the sentence from which it was generated. The candidate segment may be generated using a probabilistic model. The probabilistic model may employ a Hidden Markov Model (HMM) algorithm. The inventors have discovered that using a HMM-based probabilistic model in this fashion is an intelligent method of identifying candidates for an explanatory summary, since the generated segments have been determined by the model to be likely explanatory. Additionally, processing time may be saved since every possible subsequence of a sentence need not be generated and evaluated for explanatoriness. Thus, instead of generating all possible subsequences as candidate segments, a smaller set of segments having proportionally a higher degree of explanatoriness may be generated.

Briefly turning to FIG. 2, an example of a Hidden Markov Model-based probabilistic model 200 is depicted. This probabilistic model 200 may be used to model explanatory texts. Model 200 has five states: states B1 and B2 are background (nonexplanatory) states, F is an explanatory state, I is an initial state, and F is a final state. The I and F states are for the start and end of the model's process. That is, when model 200 is applied to a sentence, the model begins in state I and ends in state F. The other states (B1, B2, and E) each output zero or more words. The model 200 itself can be further used to determine a probability that the input text portion is explanatory.

The possible word outputs of states B1, B2, and E are the word vocabulary of the text collection. The text collection is the collection of texts from which model 200 was generated. In this example, the text collection would include both the opinion data set and the background data set. As explained later, the opinion data set can be used to generate an explanatory language model for state E and the background data set can be used to generate a background language model for states B1 and B2. These language models enable the probabilistic model 200 to evaluate the features of an input text portion.

Each word in the word vocabulary has a particular probability (including zero) of being emitted from each state. Arrows between states indicate nonzero transitions probabilities from one state to the other. Model 200 models the situation where an explanatory phrase (E) in an input sentence is surrounded by nonexplanatory (background) phrases (B1, B2). Although both B1 and B2 have basically the same functionality of generating non-explanatory words, both are used in model 200 because there can exist nonexplanatory words before as well as after an explanatory phrase in a sentence. In such a case, B1 would capture a nonexplanatory phrase before the explanatory phrase, and B2 would capture a nonexplanatory phrase after the explanatory phrase. Furthermore, because an entire input sentence can be explanatory, the transition probability from I to E and from E to F are nonzero. Likewise, an entire input sentence can be non-explanatory; thus, the transition probability from B1 to B2 is nonzero. Also, transition probabilities from each state (except I and F) into itself are nonzero because the states can generate phrases of more than one word.

In statistical terms, let p(w|X) be the output probability of word w in state X, p(Xⱼ|Xᵢ) be the transition probability from state Xᵢ to Xⱼ, and p(X₁) be the initial probability of state X₁. For each sentence, s=w₁w₂ . . . wₙ, from the opinion data set, the goal is to find the state sequence Seq* which has the highest likelihood, p(s|HMM) (where HMM is model 200).

$${Seq}^{*} = {argmax}_{Seq = {X}_{1} … {X}_{n}} p ( {X}_{1} ) p ( {w}_{1} \vert {X}_{1} ) {\prod }_{i = 1}^{n - 1} p ( {X}_{i + 1} \vert {X}_{i} ) p ( {w}_{i + 1} \vert {X}_{i + 1} )$$

where Xᵢε{B1, B2, E, I, F}. The state sequence of Seq* would be something like IB1 . . . B1E . . . EB2 . . . B2F, assuming that the sentence has a non-explanatory phrase, followed by an explanatory phrase, followed by another non-explanatory phrase. The output sequence generated by the state E would be the candidate segment within the sentence.

As an illustrative example, consider a potential sentence that could be included within the opinion data set: “The touchscreen is great, it is very responsive, so I liked it.” The features of the sentence would be the individual words. When model 200 is applied to the sentence, the state sequence having the highest likelihood would be: IB1B1B1B1B1B1EEB2B2B2B2F. As shown in FIG. 2, this is because the segment “The touchscreen is great it is” would be captured by B1 since it is non-explanatory; the segment “very responsive” would be captured by E since it is explanatory; and the segment “so I liked it” would be captured by B2 since it is non-explanatory. The output sequence generated by state E would be “very responsive”, which would be the generated candidate segment.

In some examples, after generation of the candidate segment, the text corresponding to that segment may be removed from the sentence and the model 200 may be applied to the modified sentence for potential generation of another candidate segment. In the example of “The touchscreen is great, it is very responsive, so I liked it.”, it is unlikely that model 200 would generate a second candidate segment in a subsequent highest likelihood state sequence since there does not appear to be any additional explanatory phrases in the sentence. Even if model 200 did generate another candidate segment, such a segment would likely have a low explanatoriness score, and would thus be ranked low and would not be selected for inclusion in the explanatory summary, as described later.

As another example, for a sentence such as “The touchscreen is very responsive, so I liked it, and the color quality is excellent!”, there are two explanatory phrases (“very responsive” and “color quality is excellent”) separated by a non-explanatory phrase (“so I liked it and the”). Due to the state sequence of model 200, only one of these phrases would likely be captured in the highest likelihood state sequence. Accordingly, applying model 200 to the sentence a second time after removal of the first candidate segment may result in a second candidate segment.

Turning back to FIG. 1, steps 110 and 120 may be applied to all sentences in the opinion data set to generate a plurality of candidate segments. After the candidate segments have been generated, each segment may be evaluated for explanatoriness. Note that each candidate segment has already been initially evaluated for explanatoriness by model 200, which is how they were generated. However, each segment may now be scored for explanatoriness for comparison with each other. In particular, at 130 an explanatoriness score may be determined for each candidate segment using the probabilistic model, such as model 200. Segments may be evaluated for explanatoriness in a variety of ways.

Two heuristics that may be helpful for evaluating explanatoriness of a segment are (1) popularity and (2) discriminativeness relative to background information. The popularity heuristic is based on the assumption that a segment is more likely explanatory if it includes more terms that occur frequently in the opinion data set. For example, if reviews in the opinion data set frequently refer to the touchscreen as “very responsive”, it can be assumed that “very responsive” is a basis for the positive opinion of the touchscreen of Tablet Computer X.

The discriminativeness heuristic is based on the assumption that a text segment with more discriminative terms that can distinguish the segment from background information is more likely explanatory. “Background information” is information from the background data set. For example, it can be determined whether features of the segment occur with greater frequency in the opinion data set or the background data set. If the features occur with greater frequency or probability in the background data set (i.e., the background information), then it can be assumed that the segment is not very discriminative.

An implementation of these heuristics may include using a probabilistic model, such as an HMM. In an example, two generative models may be created: one to model explanatory text segments and the other to model non-explanatory text segments. In the example below, the explanatory state of HMM models explanatory text segments while BackgroundHMM models non-explanatory text segments. Accordingly, the explanatory state of HMM can be used to score the popularity of a given segment while BackgroundHMM can be used to score the discriminativeness of a given segment. Using the first data set to estimate the explanatory model may enable the measurement of popularity of a given segment. Using the second data set to estimate the non-explanatory model may enable the measurement of discriminativeness of a given segment.

In an example, probabilistic model 200 may be used to determine an explanatoriness score for the candidate segments. FIG. 3 illustrates an example of a method that can be used in this regard. Method 300 may be performed by a computing device, system, or computer, such as computing system 600 or computer 700. Computer-readable instructions for implementing method 300 may be stored on a computer readable storage medium. These instructions as stored on the medium may be called modules and may be executed by a computer.

Method 300 may begin at 310 where a probability that the candidate segment is explanatory is determined using a probabilistic model. The probabilistic model may be model 200, which was used to generate the candidate segment. At 320, a probability that the candidate segment is non-explanatory is determined using a second probabilistic model.

The second probabilistic model, referred to as BackgroundHMM, may be equivalent to model 200 (HMM) except that all incoming transition probabilities to the explanatory state E are set to zero. In particular, an initial probability of the explanatory state E may be set to zero and the transition probability of the background state B1 to the explanatory state E may be set to zero. This ensures that the model does not enter the explanatory state E when it is evaluating the candidate segment. With this setup, parameters of the second probabilistic model may be estimated in a similar way as for model 200, and the probability of the candidate segment may also be similarly determined. Because the second probabilistic model only stays in background states, the output value is likelihood that the candidate segment is generated by the background, p(s|BackgroundHMM), which can be used as a measure of discriminativeness of the candidate segment.

At 330, an explanatoriness score may be calculated based on the two probabilities. Specifically, by comparing likelihood of the model 200 with likelihood of the second probabilistic model, the explanatoriness of the candidate segment may be determined. Accordingly, in one example, for a candidate segment segment s from the input sentence o, the explanatoriness score may be defined as follows:

$${Score}_{E} ( s ) = \frac{p ( o \vert HMM )}{p ( o \vert BackgroundHMM )} .$$

Segments having a higher Score_{E} are considered to be more explanatory than segments having a lower Score_{E}.

Additional examples and details of evaluating and scoring explanatoriness may be found in U.S. patent application Ser. No. 13/485,730, entitled “Generation of Explanatory Summaries” by Kim et al., filed on May 31, 2012, and U.S. patent application Ser. No. 13/766,019, entitled “Determining Explanatoriness of Segments” by Kim et al., filed on Feb. 13, 2013, which have been incorporated by reference.

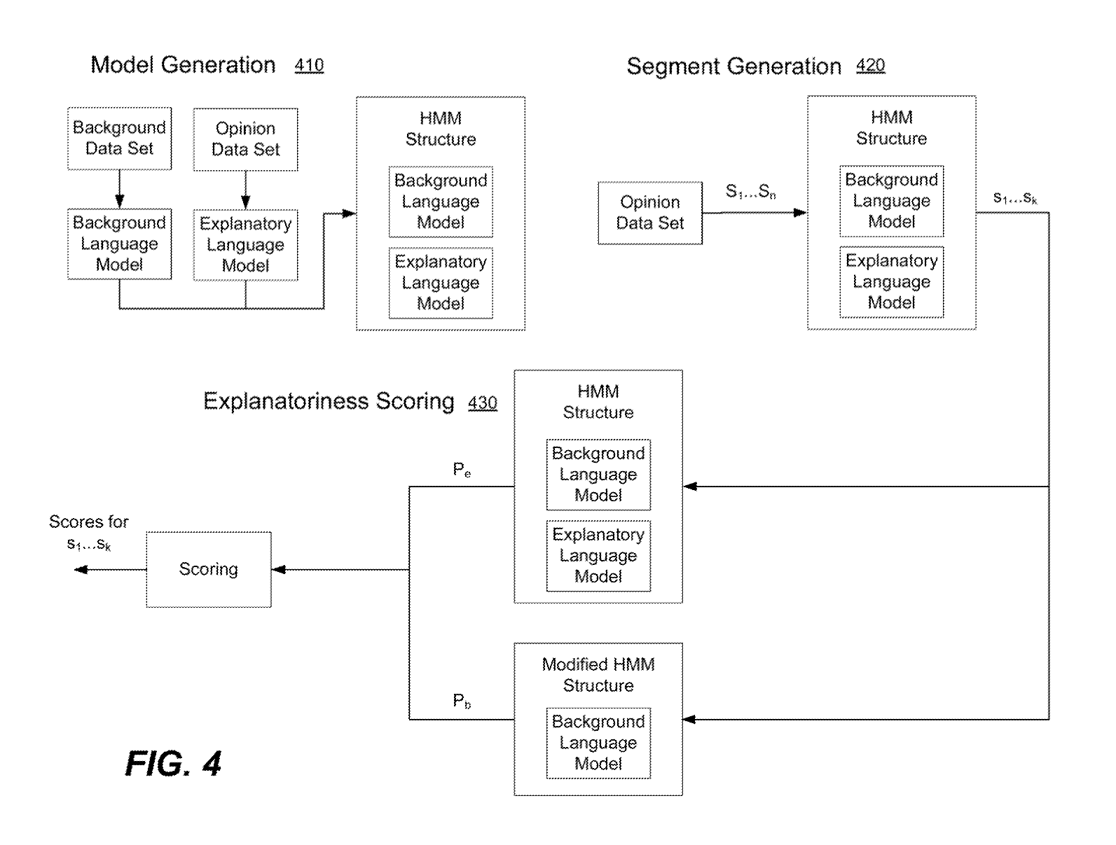

FIG. 4 illustrates a process overview for generating and scoring segments, according to an example. The overview includes three phases: model generation 410, segment generation 420, and explanatoriness scoring 430.

During model generation 410, the background data set can be used to generate a background language model and the opinion data set can be used to generate an opinion language model. A language model is a statistical model that assigns a probability to a sequence of words based on a probability distribution. Because the background language model is estimated using the background data set, the background language model can be used to determine likelihood that a sequence of words in a text portion was generated from the background data set. Similarly, because the opinion language model is estimated using the opinion data set, the opinion language model can be used to determine likelihood that a sequence of words in a text portion was generated from the opinion data set. In statistical terms,

$$p ( {w}_{i} \vert B ) = \frac{c ( {w}_{i} , T )}{\vert T \vert} , p ( {w}_{i} \vert E ) = \frac{c ( {w}_{i} , O )}{\vert O \vert}$$

where B corresponds to the background states B1 and B2, E corresponds to the explanatory state, and c(w,C) is the count of word w in word collection C. For p(wᵢ|B), the word collection is the background data set, represented as T in the equation. For p(wᵢ|E), the word collection is the opinion data set, represented as O in the equation. These language models can be used to estimate the output probabilities of the explanatory and background states of the HMM structure.

Once the output probabilities of the background and explanatory states are set, the transition probabilities of the HMM structure (e.g., probabilistic model 200) can be learned from an observed sequence, such as each sentence of the input data set. In one example, these probabilities could be learned from training data. However, for an unsupervised technique, the probabilities can be learned using the Baum-Welch algorithm, where each sentence of the input data set is used as the only observed sequence.

During segment generation 420, sentences S₁ . . . Sₙ (n being the number of sentences in the data set) may be input to the HMM structure for generation of candidate segments s₁ . . . sₖ (k being the number of segments generated from all of the sentences in the data set). This process may be similar to 110 and 120 of method 100. During explanatoriness scoring 430, the candidate segments s₁ . . . sₖ may be input into the HMM structure and into the modified HMM structure. The HMM structure can output a probability Pₑ that a given candidate segment is explanatory. Of course, since the candidate segments were generated by the HMM structure at 420, it is not necessary to remodel the HMM for the candidate segments to determine Pₑ for each segment. Instead, the Pₑ for each segment may be stored during segment generation 420 to be used during explanatoriness scoring 430. The modified HMM structure can output a probability P_{b} that a given candidate segment is non-explanatory (i.e., relates to background information). The probabilities Pₑ and P_{b} may be used to generate an explanatoriness score for each of the candidate segments s₁, . . . sₖ. This process may be similar to 130 of method 100 and to method 300.

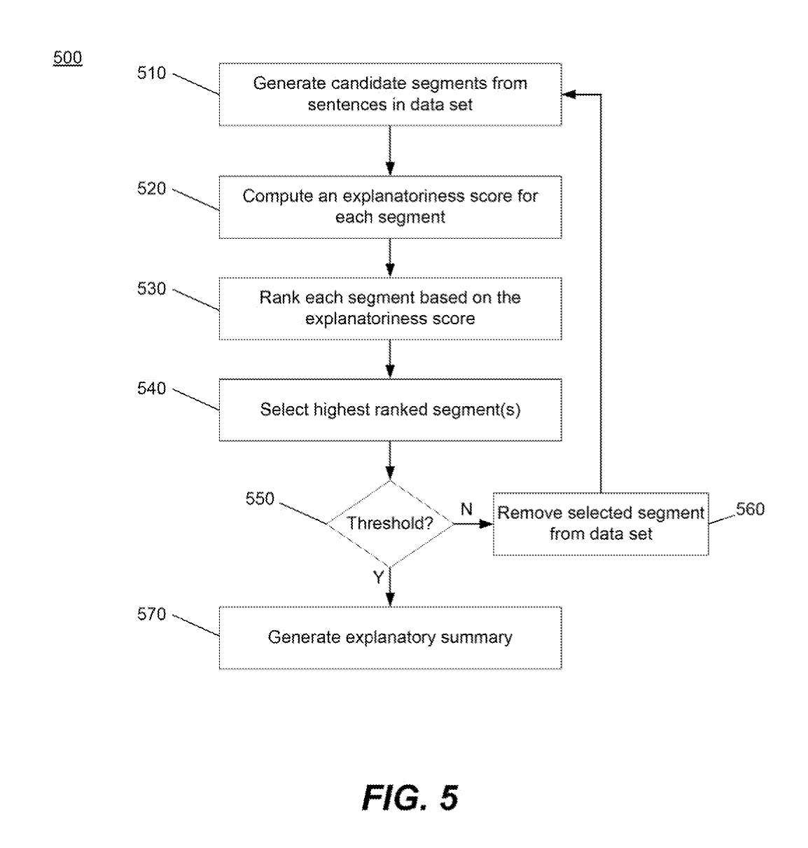

FIG. 5 illustrates a method of generating an explanatory summary, according to an example. Method 500 may be performed by a computing device, system, or computer, such as computing system 600 or computer 700. Computer-readable instructions for implementing method 500 may be stored on a computer readable storage medium. These instructions as stored on the medium may be called modules and may be executed by a computer.

At 510, candidate segments may be generated, similar to 110 and 120 of method 100. At 520, an explanatoriness score may be computed for each segment, similar to 130 of method 100. At 530, each segment may be ranked based on its respective explanatoriness score. A segment with a higher explanatoriness score can be ranked higher than a segment with a lower explanatoriness score. Ranking may include various things, such as sorting the segments based on the explanatoriness scores, assigning a priority to each segment based on its explanatoriness score, or simply scanning the explanatoriness scores and keeping track of the highest score along with an indication of the corresponding segment.

At 540, the highest ranked segment may be selected for inclusion in the explanatory summary. The segment may be immediately added to the summary or it may be added at a later time. In some examples, before a segment is selected for inclusion in the explanatory summary, the segment may be compared to previously selected segments to ensure that the segment is not redundant to the previously selected segments. The comparison may include comparing features of the segments.

At 550, it can be determined whether a threshold has been met. The threshold may be measured in various ways. For example, the threshold may be a specified number of segments or a specified number of total words. Alternatively, the threshold may be a minimum explanatory score. For instance, it may be decided that regardless of how many segments have been selected for inclusion in the explanatory summary, method 500 should stop when the explanatory scores of the segments drop below a certain value.

If the threshold has been met (“Y” at 550), method 500 may proceed to 570 where the explanatory summary is generated. Generation of the explanatory summary may include adding the selected segments to the summary in a readable fashion. For example, the segments may be numbered or separated by one or more of various separators, such as commas, periods, carriage returns, or the like. The summary may additionally be output, such as to a user via a display device, printer, email program, or the like.

If the threshold has not been met (“N” at 550), method 500 may proceed to 560 where the selected segment is removed from the data set. Method 500 may then proceed to 510, where new candidate segments may be generated from the modified data set (i.e., the data set with the previously selected segment removed therefrom). In some examples, new candidate segments may be generated only from the sentence from which the removed segment came.

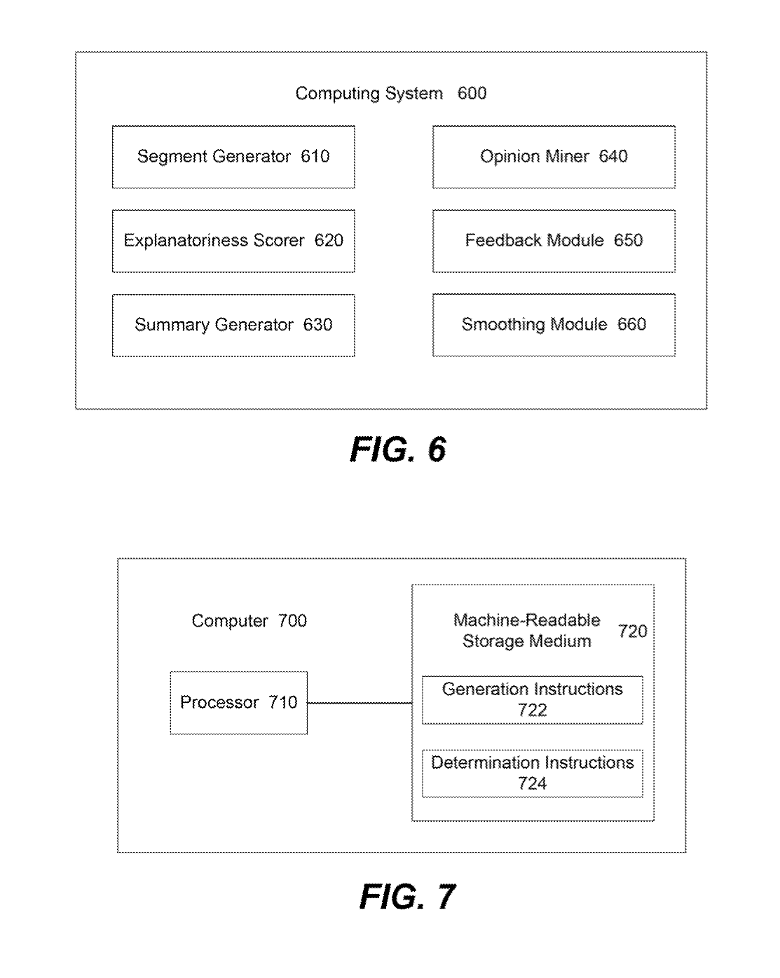

Various modifications may be made to method 100 and 500 by those having ordinary skill in the art. For example, block 540 may be modified to select a certain number of highest ranked segments rather than just a single segment. In another example, method 500 may proceed to block 540 if the threshold is not met. Feedback and smoothing, as described below with respect to FIG. 6 may also be incorporated into method 500. Various other modifications may be made as well and still be within the scope of the disclosure.

FIG. 6 illustrates a system for generating and scoring segments, according to an example. Computing system 600 may include and/or be implemented by one or more computers. For example, the computers may be server computers, workstation computers, desktop computers, or the like. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, computing system 600 may include one or more machine-readable storage media separate from the one or more controllers.

Computing system 600 may include segment generator 610, explanatoriness scorer 620, summary generator 630, opinion miner 640, feedback module 650, and smoothing module 660. Each of these components may be implemented by a single computer or multiple computers. The components may include software, one or more machine-readable media for storing the software, and one or more processors for executing the software. Software may be a computer program comprising machine-executable instructions.

In addition, users of computing system 600 may interact with computing system 600 through one or more other computers, which may or may not be considered part of computing system 600. As an example, a user may interact with system 600 via a computer application residing on system 600 or on another computer, such as a desktop computer, workstation computer, tablet computer, or the like. The computer application can include a user interface.

Computer system 600 may perform methods 100, 300, and 500, and components 610-660 may be configured to perform various portions of methods 100, 300, and 500. Additionally, the functionality implemented by components 610-660 may be part of a larger software platform, system, application, or the like. For example, these components may be part of a data analysis system.

Segment generator 610 may be configured to generate a plurality of segments from sentences in a first data set using a multi-state HMM structure. The multi-state HMM structure may be configured such that it includes an explanatory state based on an explanatory language model that estimates explanatoriness. The structure may be further configured so that it includes a background state based on a background language model that estimates non-explanatoriness. The plurality of segments may be based on output sequences of the explanatory state.

Explanatoriness scorer 620 may be configured to generate an explanatoriness score of each segment using the multi-state HMM structure. Summary generator 630 may be configured to generate a summary of the first data set based on the explanatoriness scores. The summary may include only a subset of the segments.

Opinion miner 640 may be configured to identify clusters in a second data set. The first data set may correspond to a cluster identified in the second data set. The explanatory language model of the multi-state HMM structure may be generated from the first data set. The background language model may be generated from the second data set.

Feedback module 650 may be configured to modify the explanatory language model using the plurality of segments. Adding words from the initial segment generation can enhance the explanatory language model, similar to pseudo feedback in information retrieval. It is assumed that the generated segments are explanatory (pseudo-explanatory). From the first run of the multi-state HMM structure over all the sentences in O (the opinion data set), we have initial text segment extraction results, and using the extracted words a feedback language model E* can be produced. Accordingly, the current explanatory language model can be smoothed with this pseudo explanatory model.

$${p}^{′} ( {w}_{i} \vert E ) = \frac{c ( {w}_{i} , O ) + {μ}_{1} p ( {w}_{i} \vert {E}^{*} )}{\vert O \vert + {μ}_{1}}$$

where μ₁ is the parameter controlling strength of feedback.

Smoothing module 660 may be configured to modify the multi-state HMM structure to reduce overfitting to the explanatory state. The basic model above uses maximum likelihood estimator to model an explanatory language state. Because the vocabulary of the input data set is not big enough compared to the one in the background data set, the estimated output probabilities may be too big compared to those in an ideal explanatory language model (which would include all possible explanatory sentences). In addition, because the current observing sentence used for transition probability estimation is a part of O, there is a concern that the trained HMM may overfit to the explanatory state. That is, it may stay at the explanatory state too long.

One easy way to avoid this problem is by excluding the observing sentence in modeling the explanatory language model. That is, when estimating the explanatory language model for a segment sᵢ, we can use other sentences in O.

A more formal method for avoiding overfitting is to smooth the explanatory language model. One way to smooth is by using Laplacian smoothing, which adds uniform weighting to each word. The smoothed model can be defined as follows:

$${p}^{′} ( {w}_{i} \vert E ) = \frac{c ( {w}_{i} , O ) + δ}{\vert O \vert + \vert {V}_{o} \vert δ}$$

where V_{O} is vocabulary in O, and δ is a parameter controlling the strength of Laplacian smoothing.

Another method to smooth the explanatory state is by using Dirichlet smoothing to the background language model. While Laplacian smoothing just decreases word probability in the explanatory language model, Dirichlet smoothing decreases the gap between the explanatory state and the background states by mixing them. Although this may be closer to the reality, one possible disadvantage of this approach is that the explanatory state becomes progressively similar to background states, which weakens the HMM's power to find explanatory segments. This smoothed model may be defined as follows:

$${p}^{′} ( {w}_{i} \vert E ) = \frac{c ( {w}_{i} , O ) + {μ}_{0} p ( {w}_{i} \vert T )}{\vert O \vert + {μ}_{0}}$$

where μ₀ is a parameter controlling the strength of Dirichlet smoothing.

FIG. 7 illustrates a computer-readable medium for generating and scoring segments, according to an example. Computer 700 may be any of a variety of computing devices or systems, such as described with respect to computing system 600.

Processor 710 may be at least one central processing unit (CPU), at least one semiconductor-based microprocessor, other hardware devices or processing elements suitable to retrieve and execute instructions stored in machine-readable storage medium 720, or combinations thereof. Processor 710 can include single or multiple cores on a chip, multiple cores across multiple chips, multiple cores across multiple devices, or combinations thereof. Processor 710 may fetch, decode, and execute instructions 722, 724 among others, to implement various processing. As an alternative or in addition to retrieving and executing instructions, processor 710 may include at least one integrated circuit (IC), other control logic, other electronic circuits, or combinations thereof that include a number of electronic components for performing the functionality of instructions 722, 724. Accordingly, processor 710 may be implemented across multiple processing units and instructions 722, 724 may be implemented by different processing units in different areas of computer 700.

Machine-readable storage medium 720 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 720 can be computer-readable and non-transitory. Machine-readable storage medium 720 may be encoded with a series of executable instructions for managing processing elements.

The instructions 722, 724 when executed by processor 710 (e.g., via one processing element or multiple processing elements of the processor) can cause processor 710 to perform processes, for example, methods 100, 300, 500, and variations thereof. Furthermore, computer 700 may be similar to computing system 600 and may have similar functionality and be used in similar ways, as described above. For example, generation instructions 722 may cause processor 710 to generate a candidate segment from a sentence using a probabilistic model. The probabilistic model may employ an HMM algorithm. The candidate segment may correspond to a sequence of features within the sentence. Determination instructions 724 may cause processor 710 to determine an explanatoriness score of the candidate segment using the probabilistic model and a modified version of the probabilistic model. An explanatory summary may be generated by selecting candidate segments having a high explanatoriness score.

What is claimed is:

1. A method, comprising:
determining features of a sentence;
generating a candidate segment from the features of the sentence using a probabilistic model, the probabilistic model employing a Hidden Markov Model (HMM) algorithm; and
determining an explanatoriness score of the candidate segment using the probabilistic model.

2. The method of claim 1, wherein the probabilistic model includes an explanatory state and a background state, the explanatory state being associated with a first language model and the background state being associated with a second language model.

3. The method of claim 2, wherein the candidate segment corresponds to an output sequence of the explanatory state.

4. The method of claim 2, wherein the first language model is generated using a first data set that includes information associated with an opinion and the second language model is generated using a second data set that includes background information, the second data set being a superset of the first data set.

5. The method of claim 4, wherein the second data set includes opinion data regarding a product regardless of aspect or polarity and the first data set includes opinion data having a polarity and relating to an aspect of the product, wherein the second data set is generated from the first data set using an opinion miner.

6. The method of claim 2, wherein determining an explanatoriness score of the candidate segment using the probabilistic model comprises:
determining a probability that the candidate segment is explanatory using the probabilistic model; and
determining a probability that the candidate segment is non-explanatory using a second probabilistic model, the second probabilistic model being equivalent to the probabilistic model except that an initial probability of the explanatory state is zero and a transition probability of the background state to the explanatory state is zero.

7. The method of claim 1, further comprising:
removing the candidate segment from the sentence; and
generating a second candidate segment from the sentence using the probabilistic model.

8. The method of claim 1, wherein the sentence comes from a data set, the method further comprising:
performing the determining, generating, and determining steps of claim 1 on additional sentences within the data set.

9. The method of claim 8, further comprising:
ranking the candidate segments based on their explanatoriness scores.

10. The method of claim 9, further comprising:
generating an explanatory summary by selecting the top N ranked segments, wherein N is a limit.

11. The method of claim 10, wherein before a segment is selected for inclusion in the explanatory summary, the segment is compared to previously selected segments to ensure that the segment is not redundant to the previously selected segments.

12. A system, comprising:
a segment generator to generate a plurality of segments from sentences in a data set using a multi-state Hidden Markov Model (HMM) structure;
an explanatoriness scorer to generate an explanatoriness score of each segment using the multi-state HMM structure; and
a summary generator to generate a summary of the data set based on the explanatoriness scores, the summary including a subset of the plurality of segments.

13. The system of claim 12, wherein the multi-state HMM structure includes an explanatory state based on an explanatory language model that estimates explanatoriness and a background state based on a background language model that estimates non-explanatoriness, the plurality of segments being generated based on output sequences of the explanatory state.

14. The system of claim 13, comprising an opinion miner to identify clusters in a second data set, the data set corresponding to an identified duster, wherein the explanatory language model is generated from the data set and the background language model is generated from the second data set.

15. The system of claim 13, further comprising a feedback module to modify the explanatory language model using the plurality of segments.

16. The system of claim 13, further comprising a smoothing module to modify the multi-state HMM structure to reduce overfitting to the explanatory state.

17. A non-transitory computer readable storage medium storing instructions that, when executed by a processor, cause a computer to:
generate a candidate segment from a sentence using a probabilistic model, the probabilistic model employing a Hidden Markov Model (HMM) algorithm, the candidate segment corresponding to a sequence of features within the sentence; and
determine an explanatoriness score of the candidate segment using the probabilistic model and a modified version of the probabilistic model.
